(19) United States
(12) Patent Application Publication
(10) Pub. No.: US 2015/0199544 A1
(43) Pub. Date: Jul. 16, 2015

(54) MODIFIED BEGGS & BRILL MULTIPHASE FLOW CORRELATION WITH FUZZY LOGIC FLOW REGIME PREDICTION

(71) Applicant: King Fahd University of Petroleum and Minerals, Dhahran (SA)

(72) Inventors: Muzammil Hussain RAMMAY, Karachi (PK); Sami Abdulaziz ALNUAIM, Dhahran (SA)

(73) Assignee: King Fahd University of Petroleum and Minerals, Dhahran (SA)

(21) Appl. No.: 14/156,649

(22) Filed: Jan. 16, 2014

(51) Int. Cl. G06G 7/50; G01L 7/00; G01F 1/00

(52) U.S. Cl. CPC G06G 7/50; G01F 1/00; G01L 7/00

(57) ABSTRACT

An improved method using fuzzy logic for predicting liquid slip holdup in multiphase flow in pipes. The method improves the Beggs and Brill multiphase flow correlation. Fuzzy sets are defined for all variables in the Beggs Brill liquid-slip holdup equation horizontal multiphase flow. Fuzzy logic is used to calculate the Beggs Brill a, b, and c coefficients from known values for Froude number and the no-slip holdup. Using the Minami and Brill data set and the Abdul Majeed data set the fuzzy logic prediction of liquid slip holdup is compared to the Beggs Brill correlation, the modified Beggs Brill correlation, and several other multiphase correlations. Using a variety of error metrics the fuzzy logic predictions perform better than all other multiphase correlations.

### BACKGROUND

1. Field of the Disclosure

The present invention relates generally to predicting multiphase flow in pipes, and more particularly to predicting the horizontal flow liquid slip holdup.

2. Description of the Related Art

Multiphase flows are important to a large variety of industries including: geothermal power generation, nuclear reactor technology, electrical power generation, food production, chemical processes, aerospace, automotive, and petroleum industries. For example, multiphase flow occurs in almost all producing oil and gas wells and surface pipes transporting produced fluids. Significant differences in density and viscosity for the fluids make multiphase flow much more complicated than single phase flow. Although multi-phase flow is relevant to many industries, multiphase flow in the petroleum industry is unique due to the larger diameters pipes, the longer lengths of the pipes, and the hostile environments. Production of oil and gas has become more complicated due to offshore discoveries, initially in shallow and now in ultra deep water and in harsh arctic climates. Capital costs are very high in these regions, and production systems require design with more accuracy than possible with early empirical correlations. These empirical correlations are developed from measured data. The empirical correlations predict flow patterns, liquid holdup, and friction factor such that pressure drop can be predicted along a pipe. Using empirical correlations, engineers with the help of nodal-analysis software can design production systems.

Beggs and Brill multiphase flow correlation is one of the most widely used multiphase flow correlations in the industry due to its applicability for horizontal, vertical and inclined multiphase flow modeling as discussed in Neaim Sami and Aqqour M, “Evaluation of Horizontal Multiphase Flow Correlations”, Middle East Oil Shadow, Society of Petroleum Engineers, Bahrain, 1992, herein incorporated by reference in its entirety. It also takes into account the different horizontal and vertical flow regimes as discussed in Beggs, H. D. and Brill J. P.: “A Study of Two-Phase Flow in Inclined Pipes,” Journal of Petroleum Technology, p. 607 (May 1973), herein incorporated by reference in its entirety. It uses the general mechanical energy balance and the average in-situ density to calculate the pressure gradient. However, due to the complex flow regimes and its wide transition, the predictions using the Beggs Brill correlation become poor in certain practical conditions especially when flow pattern classification parameters are near to the boundaries of the flow regime limits. These poor predications primarily arise from the inaccurate calculation of slip liquid hold-up as discussed in James P. Brill and Hemanta Mukherjee, “Multiphase flow in wells”, Society of Petroleum Engineers Monograph Series Vol. 17, Richardson, Tex., 1999, herein incorporated by reference in its entirety.

Although some better empirical correlations (e.g. the Beggs Brill correlation) have survived the test of time, they all suffer from significant errors in some ranges of input variables because of their simplistic nature. Some of the errors in the Beggs Brill correlation can be improved using the fuzzy flow pattern map discussed in the detailed description. In general, all of the empirical correlations use flow pattern maps. In a flow pattern map the parameter space (e.g. parameters Froude number and no-slip holdup in the Beggs Brill correlation) is divided into regions associated by flow pattern. For example, FIG. 1 shows a flow pattern map for the original Beggs Brill correlation (solid line) and the modified Beggs Brill correlation (dashed line). FIG. 2 shows flow patterns corresponding to the segregated, intermittent, and distributed regimes. Whereas other empirical correlations are either primarily associated with either vertical flow (see, e.g., Duns and Ros; Ork iszewski; Hagedorn and Brown; Aziz, Govier, and Fogarsi; and Chiecrice, Ciucci, and Sclocchi as discussed in Chapter 3 of Brill J. P. and Beggs H. D., “Two phase flow in pipes, 6th Ed.”, University of Tulsa, Tulsa Okla. (1991)) or with horizontal flow (see, e.g., Eaton et al.; Duckler et al.; Guzhov et al.; Lockhar and Martinelli; Yocum; Liemans; Hughmark and Pressburg; and Taitel-Dukler discussed in Chapter 4 of Brill J. P. and Beggs H. D., “Two phase flow in pipes, 6th Ed.”, University of Tulsa, Tulsa Okla. (1991)), the Beggs and Brill correlation can be used for both horizontal flow, vertical flow, and of all angles in between horizontal and vertical flow. A brief review of the Beggs Brill correlation is presented here, but a complete description can be found in Beggs, H. D. and Brill J. P., “A Study of Two-Phase Flow in Inclined Pipes,” Journal of Petroleum Technology, p. 607 (May 1973), and in Brill J. P. and Beggs H. D., “Two phase flow in pipes, 6th Ed.”, University of Tulsa, Tulsa Okla. (1991),herein incorporated by reference in its entirety.

The original Beggs Brill two-phase flow model determined the flow pattern based on the Fronde number, N_{FR} and the no-slip holdup, λ_{L}. The correlation rules for this model are:
1) If N_{FR}<L₁, the flow pattern is segregated;
2) If N_{FR}>L₁ and N_{FR}>L₂, the flow pattern is distributed;
3) If N_{FR}>L₁ and N_{FR}<L₁, the flow pattern is intermittent;
   where

L₁=exp(−4.62−3.757 X−0.481 X²−0.0207 X³),

L₂=exp(1.061−4.602 X−1.609 X²−0.179 X³−0.000635 X⁵),

and
X=ln(λ_{L}). The liquid holdup was calculated using the expression

H_{L}(θ)=H_{L}(0){1+C[sin(1.8θ)−sin³(1.8θ)/3}].

where the zero angle liquid slip holdup is given by H_{L}(0)=aλ^{b}/N_{FR}^{c}, C=(1−λ)ln(dλ^{s}Nᵥₗ^{f}N_{FR}^{g}) with the values for a, b,c, d, e, f and g are given for each flow pattern in Table 1 and Table 2.

TABLE 1
Beggs Brill correlation a, b, and c coefficients.

| Flow Pattern | a | b | c |
|---|---|---|---|
| Segregated | 0.98 | 0.4846 | 0.0868 |
| Intermittent | 0.846 | 0.5351 | 0.0173 |
| Distributed | 1.065 | 0.5824 | 0.0609 |

TABLE 2
Beggs Brill correlation d, e, f, and g coefficients.

| Flow Pattern | d | e | f | g |
|---|---|---|---|---|
| Segregated uphill | 0.011 | −3.768 | 3.539 | −1.614 |
| Intermittent uphill | 2.96 | 0.305 | −0.4473 | 0.0978 |

| | |
|---|---|
| Distributed uphill | No correction, C = 0 |

| | | | | |
|---|---|---|---|---|
| All regimes downhill | 4.7 | −0.3692 | 0.1244 | −0.5056 |

Using the modified Beggs Brill correlation and flow pattern map the correlation rules are:
1) If N_{FR}<L₁, and λ_{L}<0.01, or if N_{FR}<L₂, and λ_{L}>0.01, the flow pattern is segregated;
2) If L₂≦N_{FR}≦L₃, and λ_{L}≧0.01, the flow pattern is transition;
3) If L₃<N_{FR}≦L₁, and 0.4>λ_{L}≧0.001, or if L₃<N_{FR}≦L₄, and λ_{L}≧0.4 the flow pattern is intermittent;
4) If N_{FR}≧L₁, and λ_{L}<0.4, or if N_{FR}>L₄, and λ_{L}≧0.4, the flow pattern is segregated;
   where

L₁=316 λ_{L}^{0.0302},

L₂=0.0009252 λ_{L}^{2.4684},

L₃=0.1 λ_{L}^{-1.4516},

L₄=0.5 λ_{L}^{6.738}.

The expressions given above are used to calculate the liquid slip holdup, except for the case of a transition flow pattern. For transition flow pattern the liquid slip hold up is calculated using the expression

H_{L,transition}=[(L₃−N_{FR})H_{L,segregated}+(N_{FR}−L₂)×H_{L,intermittent}]/(L₃−L₂).

In addition to predicting flow patterns and calculating the liquid slip holdup, the Beggs Brill correlation can be used to calculate the friction factor, and pressure drop along a pipe. Detailed descriptions of these calculations can be found in Beggs, H. D. and Brill J. P.: “A Study of Two-Phase Flow in Inclined Pipes,” Journal of Petroleum Technology, p. 607 (May 1973), and in Brill J. P. and Beggs H. D., “Two phase flow in pipes 6^{th} Edition”, U. of Tulsa, Tulsa Okla. (1991).

### SUMMARY OF THE INVENTION

In one aspect, the present disclosure provides an improved method of predicting liquid slip holdup in horizontal multiphase flow in pipes, where the Beggs Brill correlation is modified such that use fuzzy logic is used to calculate the Beggs Brill a, b, and c coefficients used in the Beggs Brill liquid slip holdup equation H_{L}(0)=aλ_{L}^{b}/N_{FR}^{c}. The method including the steps of defining fuzzy sets and membership functions for the inputs (i.e. Froude number, N_{FR}, and a no-slip holdup, λ_{L}) and outputs (i.e. the Beggs Brill a, b, and c coefficients). Also, fuzzy inference rules are defined relating the input fuzzy sets to output membership functions. Froude number and no-slip holdup membership values are calculated by applying the single-valued Froude number and no-slip holdup to their respective membership values. Antecedents to the inference rules are derived by applying fuzzy logic operations to the Froude number and no-slip holdup membership values. The output membership functions are calculated by applying an implication method to the antecedents and output membership functions. Aggregating the output membership functions and applying the defuzzification method results in a single value for each of the Beggs Brill a, b, and c coefficients. The liquid slip holdup for horizontal flow is calculated by applying the resultant Beggs Brill a, b, and c coefficients and the input Froude number and no-slip holdup in the Beggs Brill liquid slip holdup equation.

In one aspect, the present disclosure provides that the defuzzification method is the centroid method.

In one aspect, the present disclosure provides that the fuzzy logic OR operation outputs the maximum of two input membership values, and the fuzzy logic AND operator outputs the minimum of two input membership values.

In one aspect, the present disclosure provides that the implication method employed by the fuzzy inference rules is the minimum implication method, wherein the output membership functions are truncated such that where the input membership function, exceed the antecedent the output membership function equal the antecedent.

In one aspect, the present disclosure provides that the aggregation rule is to sum over the output sets for all fuzzy inference rules.

In one aspect, the present disclosure provides that the aggregation rule is to take the maximum of all output sets for all fuzzy inference rules.

In one aspect, the present disclosure provides that the improved method of predicting liquid slip holdup in horizontal multiphase flow in pipes is performed by a device having computer storage and processing circuitry configured to perform the steps of the method.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plot of the Beggs Brill original flow pattern map (solid line) and modified flow pattern map (dashed line). The horizontal axis shows the no-slip holdup, and the vertical axis show the Froude number as shown in FIG. 3.22 of Brill J. P. and Beggs H. D., “Two phase flow in pipes 6^{th} Edition”, U. of Tulsa, Tulsa Okla. (1991).

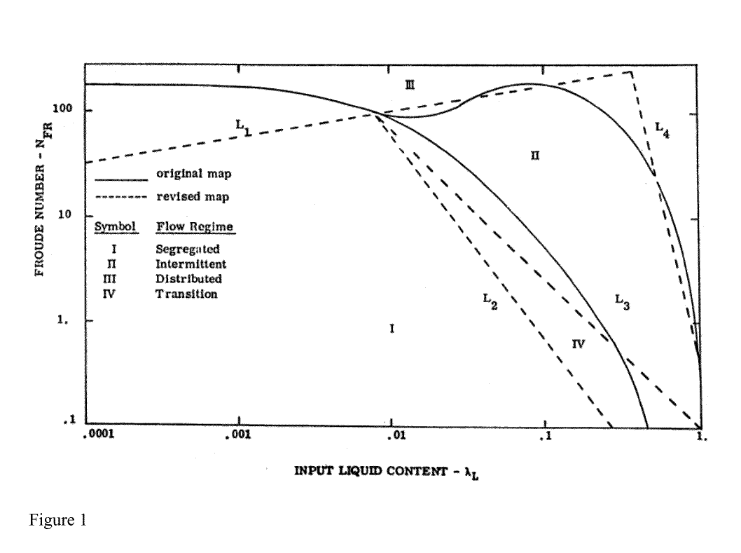

FIG. 2 is a drawing showing various flow patterns observed in multiphase flow in pipes as shown in FIG. 3.20 of Brill J. P. and Beggs H. D., “Two phase flow in pipes 6^{th} Edition”, U. of Tulsa, Tulsa Okla. (1991).

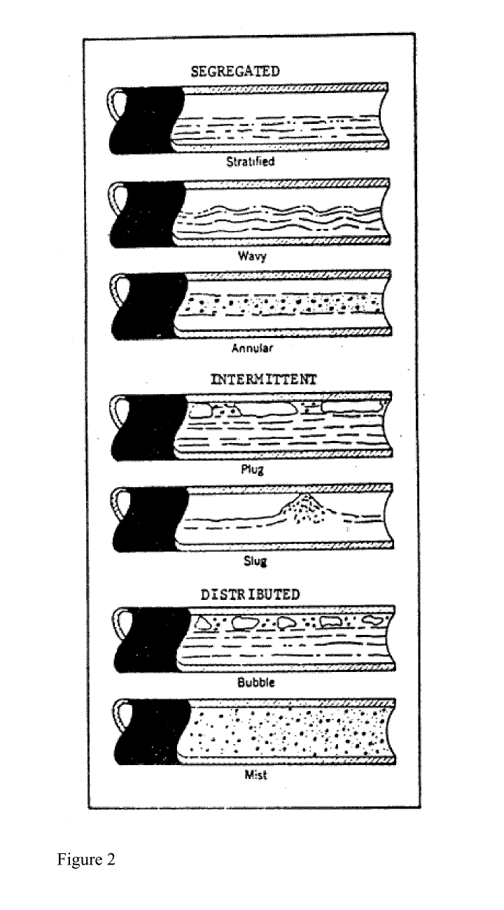

FIG. 3 is a plot of comparing the measured slip-liquid holdup from the Minami and Brill data set (horizontal axis) with the predicted slip liquid holdup brill using the proposed fuzzy model (vertical axis).

FIG. 4 is a plot of comparing the measured slip-liquid holdup from the Abdul Majeed Brill data set (horizontal axis) with the predicted slip liquid holdup brill using the proposed fuzzy model (vertical axis).

FIG. 5 is a plot of membership functions for the no-slip holdup fuzzy sets.

FIG. 6 is a plot of membership functions for the Froude number fuzzy sets.

FIG. 7 is a plot of membership functions for the Beggs Brill a, b, and c coefficient fuzzy sets.

FIG. 8 is a diagram of the min implication method for applying fuzzy inference rules as discussed on page 2-27 of “Fuzzy logic Toolbox, User's Guide R2013b”, MathWorks, Inc, September 2013.

FIG. 9 is a diagram showing an example of a fuzzy logic calculation as discussed on page 2-27 of “Fuzzy logic Toolbox, User's Guide R2013b”, MathWorks, Inc, September 2013.

FIG. 10 is a schematic of a device implementing the method of predicting liquid slip holdup using fuzzy logic.

### DETAILED DESCRIPTION OF THE PREFERRED EMBODIMENTS

Referring now to the drawings, wherein like reference numerals designate identical or corresponding parts throughout the several views.

The method of the present invention is an improvement over the Beggs Brill correlation method for predicting liquid slip holdup in multi-phase flow. The original Beggs Brill correlation and the modified Beggs Brill correlation discussed in the “description of related art” section are two of the mostly widely used multiphase flow correlations in the industry due to their applicability for horizontal, vertical and inclined multiphase flow modeling. They use the general mechanical energy balance and the average in-situ density to calculate the pressure gradient. While the Beggs Brill correlation works relatively well for tubing sizes between 1 and 1.5 inches, a broad spectrum of oil gravities, and a water-cut of up to 10%, the Beggs Brill predictions become poor in certain practical conditions, especially when the flow pattern classification parameters are near boundaries between flow regimes. These poor predictions of the Beggs Brill correlation usually arise from the inaccurate prediction of the slip liquid holdup.

The improved method differs from the Beggs Brill correlation and related methods for predicting multiphase pipe flow, by using a fuzzy flow-pattern map wherein fuzzy logic replaces traditional inequalities and fuzzy sets replace classical phase regimes. Like the Beggs Brill correlation, the fuzzy flow-pattern map uses the Froude number and the no-slip holdup (i.e. the inputs) to determine the Beggs Brill a, b, and c coefficients (i.e. the outputs). However, in contrast to the single-valued inputs and outputs in the Beggs Brill correlation, the inputs and outputs in fuzzy flow-pattern map are fuzzy sets, such that a a flow can simultaneously have non-zero membership values in multiple flow patterns, where each flow pattern is one of many fuzzy sets. This property of partial membership in multiple flow patterns enables graded continuous transitions between flow pattern regimes. These continuous transitions are in sharp contrast to the abrupt transitions at flow regime boundaries for the original and modified Beggs Brill flow pattern maps.

In addition to improving the Beggs Brill correlation method by using a fuzzy logic for the flow pattern map, the fuzzy method also incorporates additional flow regimes not considered in the Beggs Brill correlation. Also, using extended data sets published in Minami, K. and Brill, J. P.: “Liquid Holdup in Wet-Gas Pipelines, “Society of Petroleum Engineers Production Engineering, Vol. 2, p. 36 (February 1987), herein incorporated by reference in its entirety and hereafter referred to as the Minami and Brill Data set, and published in Abdul-Majeed, G. H.: “Liquid Holdup Correlations for Horizontal, Vertical and Inclined Two-Phase Flow,” Society of Petroleum Engineers (Unpublished Paper), Document ID 26279-MS, (Received Mar. 18, 1993) (available at URL http://www.onepetro.org/mslib/servlet/onepetropreview?id=00026279), herein incorporated by reference in its entirety and hereafter referred to as the Abdul Majeed data set, the fuzzy flow pattern map has been further refined beyond the Beggs Brill correlation, particularly in the high distributed and low segregated flow regimes, which were not captured by Beggs and Brill data set. The original Beggs Brill correlation has three flow pattern regimes (i.e. segregated, intermittent, and distributed), and the modified Beggs Brill correlation has four flow pattern regimes (i.e. segregated, intermittent, distributed, and transition). The fuzzy method can have many more flow regimes. For example, in one embodiment, the fuzzy method has eight flow pattern regimes for the no-slip holdup, and six flow pattern regimes for the Froude number for a matrix of 48 combinations of flow pattern regimes. These 48 regimes are reflected in the 48 inference rules discussed below.

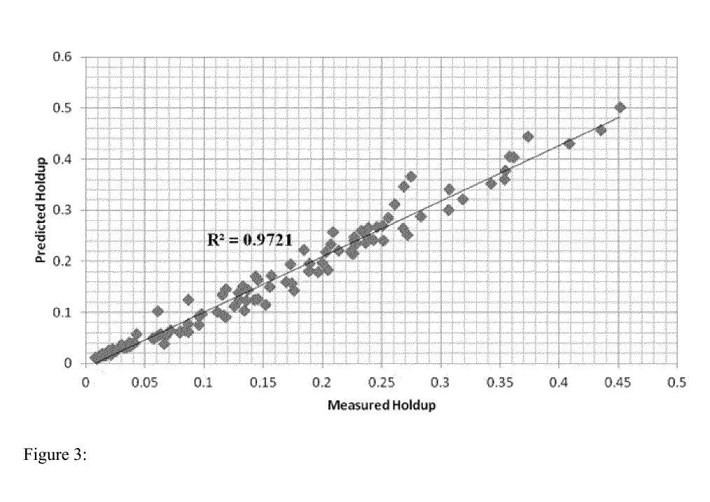

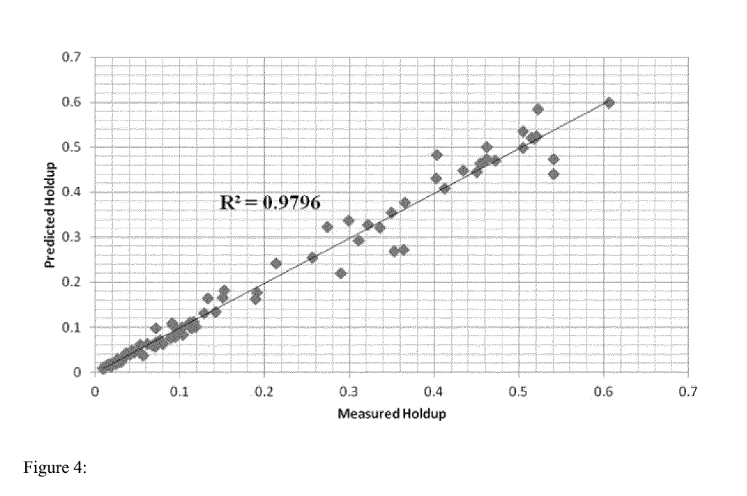

As described above, the improved method for determining liquid slip holdup, presented here, has several advantages over the original and modified Beggs Brill correlations. First, in contrast to the traditional flow pattern maps used in the Beggs Brill correlations, which assume abrupt transitions between flow patterns, flow pattern maps using fuzzy logic can have continuous graded transition at boundaries between flow patterns due to the use of fuzzy sets. Second, the fuzzy method is refined to improve predictions for highly distributed and low segregated flow regimes using published data sets from the Minami and Brill Data setandAbdul Majeed data set. The highly distributed and low segregated flow regimes were not captured by the original Beggs Brill data set and correlation. The fuzzy method, presented here, outperforms the original and modified Beggs Brill correlations and other published models. Comparisons between the fuzzy method and other published models are shown in Table 3 and Table 4, where various error measures have been used for the comparison. The statistical parameters used to evaluate the performance of the various multiphase flow models are the average absolute percentage error (AAPE), average percentage error (APE), correlation coefficient (R²) and standard deviation. FIG. 3 shows the agreement between the fuzzy model and the Minami and Brill data set. FIG. 4 shows the agreement between the fuzzy model and the Abdul Majeed data set. The error is defined as

Eᵢ=100×(H_{L}(estimated)−H_{L}(measured)/H_{L}(measured).

Absolute average percentage error (AAPE) is defined as

$$A A P E = \frac{1}{n} {\sum }_{i = 1}^{n} \vert {E}_{i} \vert .$$

Average percentage error (APE) is defined as

$$A P E = \frac{1}{n} {\sum }_{i = 1}^{n} {E}_{i} .$$

Standard deviation (SD) is defined as

$$S D = {[ \frac{n {\sum }_{i = 1}^{n} {E}_{i}^{2} - {( {\sum }_{i = 1}^{n} {E}_{i} )}^{2}}{{n}^{2}} ]}^{0.5} .$$

TABLE 3
Comparison of the new proposed correlation with Beggs and Brill
and other published multiphase flow correlations using Minami and
Brill Data Set given in Minami, K. and Brill, J. P.: “Liquid Holdup
in Wet-Gas Pipelines,” SPEPE (February 1987) 36

| Prediction method | APE (%) | AAPE (%) | SD |
|---|---|---|---|
| Eaton and Brown (1967) | −48.10 | 48.10 | 20.73 |
| Brill et al. (1981) | 34.00 | 59.00 | 97.50 |
| Gregory et al. (1978) | 722 | 722 | 860 |
| Mukherjee and Brill(1983) | −35.70 | 39.10 | 3 I.35 |
| Minami and Brill (1987) (1) | 4.35 | 14.65 | 19.35 |
| Minami and Brill(1987) (2) | −4.64 | 15.74 | 18.47 |
| Beggs and Brill (1971) | −10.70 | 26.26 | 30.70 |
| Guahov et al. (I 967) | 252.10 | 254 | 434.60 |
| Hughmark (1961) | 2.60 | 72.70 | 109.4 |
| Hughmark (1962) | 51.10 | 66.40 | 102.7 |
| Taitel and Dukler (1976) | 40.56 | 56.84 | 59.39 |
| Abdul-Majeed (1995) | 1.46 | 13.93 | 17.00 |
| Fuzzy Method | 1.46 | 12.55 | 16.65 |

TABLE 4
Comparison of the new proposed correlation with Beggs and Brill and
other published multiphase flow correlations using Abdul Majeed
Data Set given in Abdul-Majeed, G. H.: “Liquid Holdup Correlations
for Horizontal, Vertical and Inclined Two-Phase Flow,”
Paper SPE 26279, Unsolicited, Mar. 18, 1993

| Prediction method | APE (%) | AAPE (%) | SD |
|---|---|---|---|
| Eaton and Brown (1967) | −40.83 | 44.56 | 29.14 |
| Brill et al. (1981) | −50.96 | 82.76 | 160.87 |
| Gregory et al. (1978) | 494.86 | 494.86 | 656.15 |
| Mukherjee and Brill(1983) | −34.58 | 41.55 | 36.82 |
| Minami and Brill (1987) (1) | 1.26 | 13.61 | 19.15 |
| Minami and Brill(1987) (2) | 4.60 | 14.84 | 17.39 |
| Beggs and Brill (1971) | 7.06 | 25.58 | 31.76 |
| Guahov et al. (I 967) | 316.33 | 322.56 | 459.77 |
| Hughmark (1961) | 14.87 | 78.22 | 116.32 |
| Hughmark (1962) | 63.41 | 75.54 | 92.84 |
| Taitel and Dukler (1976) | 100.39 | 108.02 | 95.82 |
| Armand (1946) | 49.74 | 51.47 | 45.47 |
| Chen and Spedding (1981) | 33.72 | 35.85 | 30.97 |
| Chen and Spedding (1983) | 130.24 | 130.24 | 51.15 |
| Abdul-Majeed (1995) | −0.38 | 10.30 | 13.30 |
| Fuzzy Method | −2.78 | 9.94 | 13 |

In the typical fuzzy logic process for making decisions or predictions, the inputs and the outputs onto fuzzy sets are related to traditional single-valued variable and “crisp sets” using membership functions. The membership functions map input variables to membership values. The outputs are then derived from the input membership values using fuzzy inference rules and fuzzy logic. Specifically, the fuzzy flow pattern map operates based on fuzzy inference rules, where the antecedents to the inference rules are the fuzzy sets corresponding to the Froude number and the no-slip holdup and fuzzy logic operations based on these fuzzy sets. Also, the consequents of the inference rules are the fuzzy sets corresponding to the Beggs Brill a, b, and c coefficients. A general discussion of the fuzzy logic can be found in “Fuzzy logic Toolbox, User's Guide R2013b”, MathWorks, Inc, September 2013, herein incorporated by reference in its entirety, and found in T. J. Ross. Fuzzy Logic with Engineering Applications, 2nd ed., John Wiley & sons, 2004, herein incorporated by reference in its entirety.

The improved method of predicting the horizontal liquid slip holdup, H_{L} (0), is briefly described by the steps of: (1) defining fuzzy sets and membership functions for each variable in the Beggs Brill equation for horizontal liquid slip holdup (i.e. for the Froude number, N_{FR}, no slip holdup, λ_{L}, and Beggs Brill coefficients a, b, and c); (2) calculating the single-valued Froude number, N_{FR}, and no slip holdup, λ_{L}, for a given set of flow parameters; 3) fuzzifying the inputs (i.e. the Froude number, N_{FR}, and no slip holdup, λ_{L}) by applying the single-valued Froude number and no slip holdup to the respective membership functions, and obtaining the membership values for each input fuzzy set; (4) applying fuzzy logic operations on the input membership values to obtain antecedents for inference rules; (5) applying antecedents to the inference rules and using the implication operator on the Beggs Brill coefficient membership functions to obtain the consequent membership functions for each of the Beggs Brill coefficients; (6) for each of the Beggs Brill coefficients aggregate the consequent membership functions foomr all inference rules; (7) applying the defuzzification rule to the aggregated consequents in order to obtain a single-valued number for each Beggs Brill coefficient; (8) calculating the horizontal liquid slip holdup, H_{L}(0), by applying the single-valued Beggs Brill a, b, and c coefficients to the Beggs Brill equation, H_{L} (0)=aλ_{L}^{b}/N_{FR}^{c}.

In one non-limiting embodiment of the fuzzy method for predicting liquid slip holdup, flow regime is predicted using the calculated no-slip holdup and Froude Number. For this model, there are two inputs (no-slip holdup and Froude Number), and three outputs (Beggs and Brill Parameters a, b and c) which are associated with a particular flow regime. After the prediction of a, b and c, the slip Hold-up is calculated, which is one of the basic parameters of pressure drop calculation.

In this model, triangular membership and trapezoidal membership functions are used for input/output variables. For defuzzification, centroid method is used. MATLAB R2011b software is used for building the model.

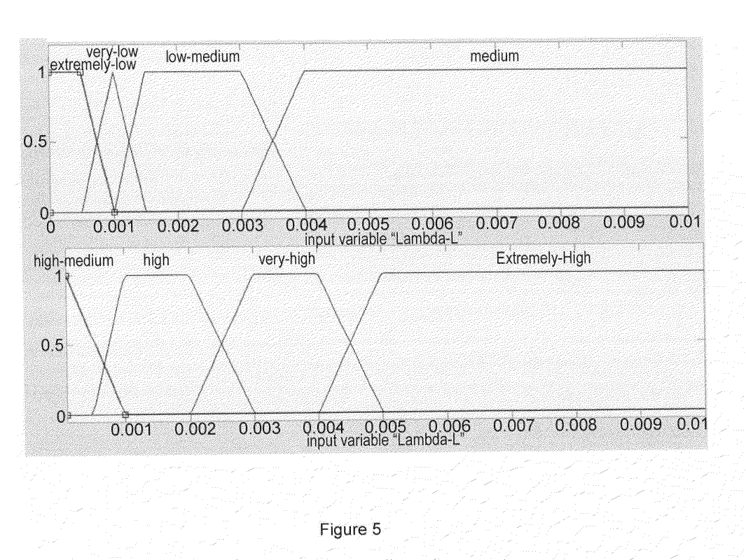

The input variable no-slip holdup is fuzzifying through the region of 0 to 1. There are 8 membership functions are used out of which ‘very low’ and ‘High medium’ are triangular and the rest are trapezoidal as shown in FIG. 5. All membership functions cover specific data ranges in input variable of no-slip holdup, e.g. ‘high medium’ covers the range from 0.01 to 0.1 with their corresponding membership values as shown in FIG. 5.

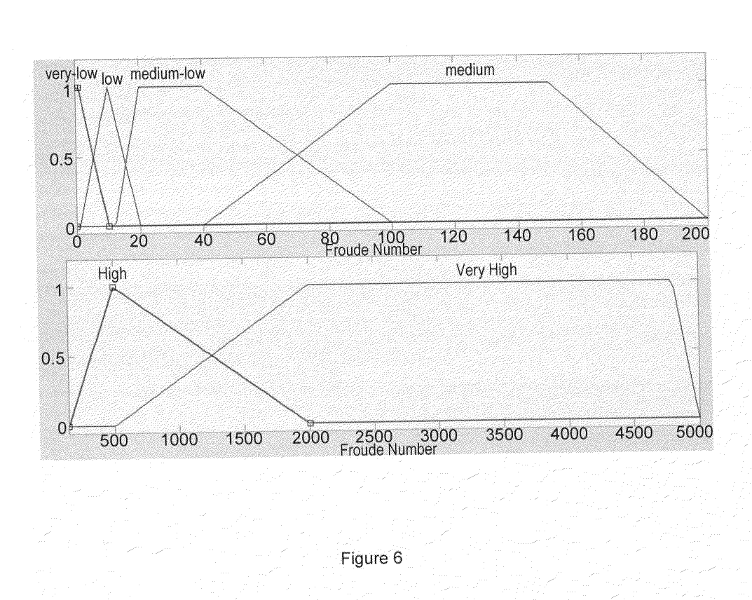

For the input variable Froude number there are 6 membership functions used out of which very-low, low and high are triangular and the rest are trapezoidal. The membership functions used for fuzzification of Froude number covers the range of 0 to 5000 as shown in FIG. 6. All membership functions cover specific data ranges in input variable of Froude Number, e.g. ‘High’ covers the range from 150 to 2000 with their corresponding membership values as shown in FIG. 6.

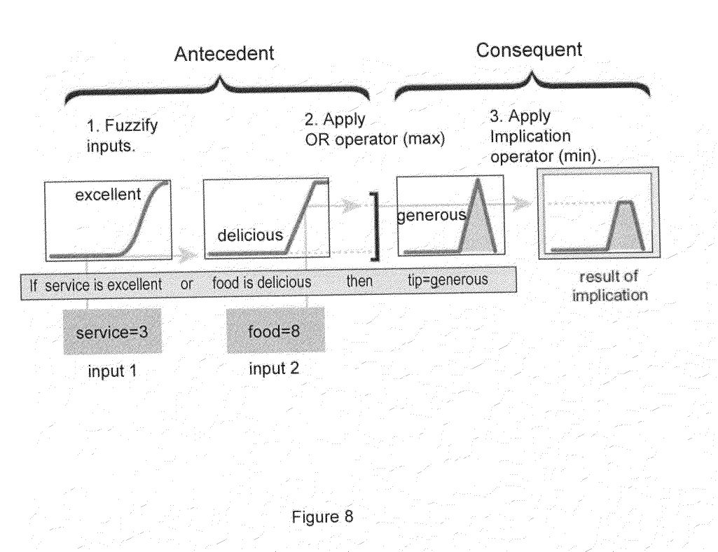

For fuzzification of output variables there are 4 membership functions used for variable a, 11 membership functions used for variable b, and 4 membership functions used for variable c. All membership functions for output variables are triangular as shown in FIG. 8.

The first three inference rules can be written as:
(1) IF (λ_{L}=“extremely-low” AND N_{FR}=“very-low”) THEN (a=segregated), (b=very-highly segregated), and (c=segregated);
(2) IF (λ_{L}=“extremely-low” AND N_{FR}=“low”) THEN (a=segregated), (b=very-highly segregated), and (c=segregated); and
(3) IF (λ_{L}=“extremely-low” AND N_{FR}=“low-medium”) THEN (a=segregated), (b=very-highly segregated), and (c=segregated),
   where the equal sign “=” in the antecedents stands for the logic operator and the equal sign “=” in the consequents stands for the assignment operator.

Rather than writing out all 48 inference rules long hand, as above, the 48 inference rules are summarized in Table 5 using a short hand that conveying the essential information. For each inference rule in Table 5 the value of the antecedent is the result of the fuzzy logic “AND” function between the membership values for the Froude number fuzzy set and no-slip holdup fuzzy set shown (i.e. for rule 1 the Froude number fuzzy set is “extremely-low” and the no-slip holdup fuzzy set is “very-low”). The antecedent for each inference rule will be a single number.

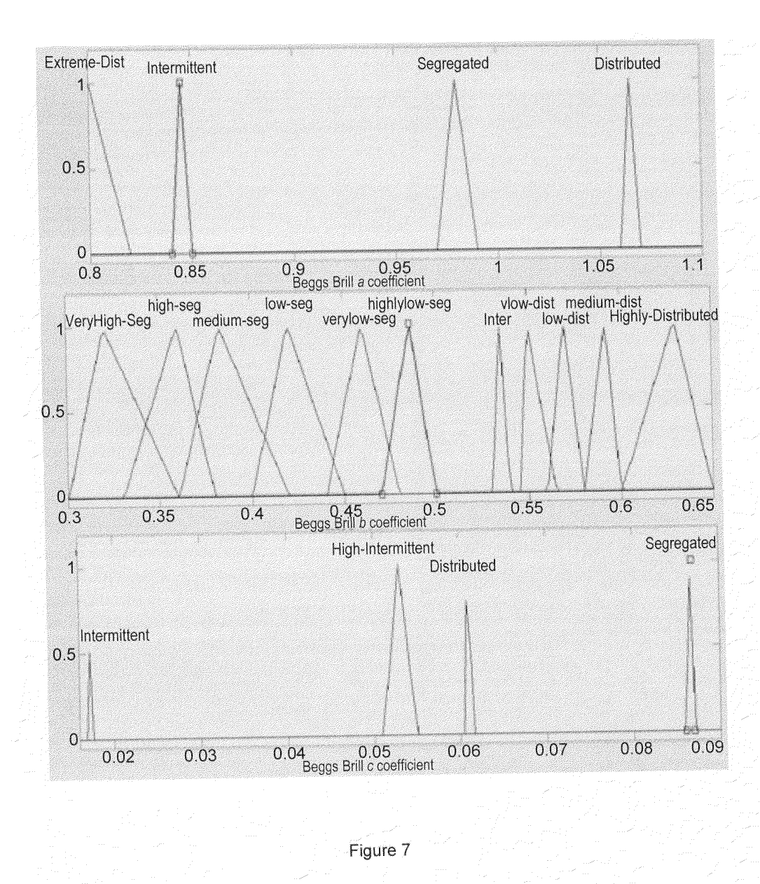

Each inference rule generates three consequent membership functions corresponding to the three Beggs Brill coefficients a, b, and c. These consequent membership functions are obtained by applying an implication method. For these results shown in FIG. 3 and FIG. 4 the min implication method was used. The min implication method simply truncates all values of the target membership function which greater than the antecedent such that they equal the antecedent. For example, for rule 1 if the antecedent value were 0.5 then the consequent membership function for the Beggs Brill a coefficient becomes the segregated triangle function shown in the top plot of FIG. 7, except all values of the triangle function greater the 0.5 are reassigned to have a value of 0.5. FIG. 8 shows an example from page 2-26 of “Fuzzy logic Toolbox, User's Guide R2013b”, MathWorks, Inc, September 2013 showing how the min implication method works. Generally, other implication rules, such as the product rule can also be used.

A unique consequent membership function is created for each inference rule and for each output variable. Thus for the 48 inference rules there will be 48 consequent membership functions for the Beggs Brill a coefficient. There will also be 48 additional consequent membership functions for the Beggs Brill b coefficient and 48 more consequent membership functions for the Beggs Brill c coefficient, for a total of 144 total consequent membership functions. For each Beggs Brill coefficient all of the consequent membership functions are aggregated to an aggregate membership function and then the defuzzification rule is applied.

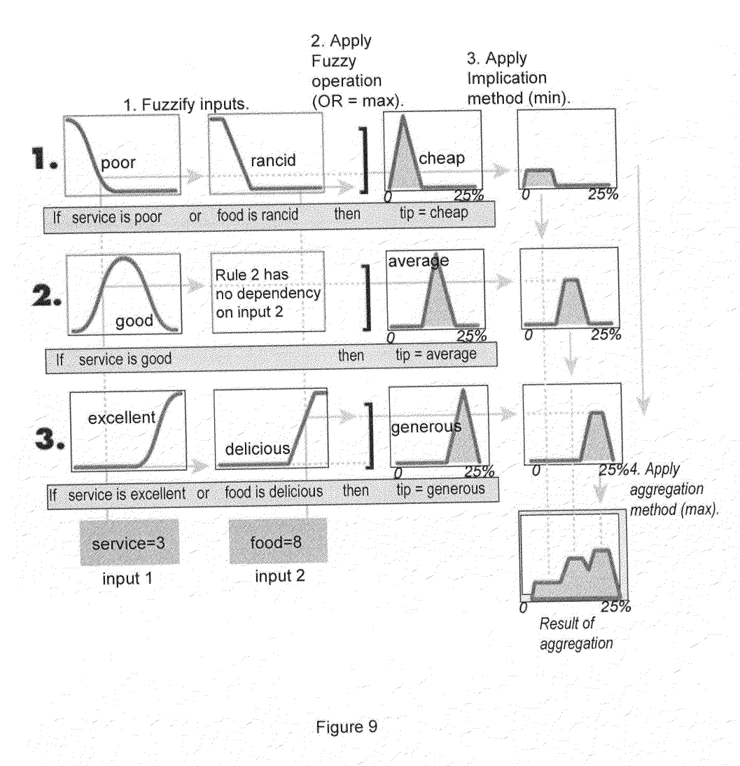

There are choices for the aggregation rule and the defuzzification rule. For the results shown in FIG. 3 and FIG. 4, the aggregation rule and defuzzification rules applied are the Matlab® defaults of the max function for aggregation and the centroid method for defuzzification. FIG. 9 shows a diagram from page 2-28 of “Fuzzy logic Toolbox, User's Guide R2013b,” by MathWorks, Inc. showing the entire fuzzy logic process for a three inference rules and a single output. In general the aggregation method can be any one of the max function (taking the maximum value of all consequent membership function), the probor function (taking the probabilistic OR of all consequent membership function), the sum function (simply the sum of each rule's output set), etc. In general the defuzzification method can be any one of the centroid method, bisector method, middle of maximum method, largest of maximum method, smallest of maximum method, etc.

After performing the defuzzification for all consequents, the result is three single-valued numbers: the Beggs Brill a coefficient, the Beggs Brill b coefficient, and the Beggs Brill c coefficient. These three values along with the initial two values for the Froude number and the no-slip holdup are then applied to the Beggs Brill horizontal liquid slip holdup equation H_{L}(0)=aλ_{L}^{b}/N_{FR}^{c}.

Additional parameters such as the liquid slip holdup for inclined and vertical flows, the friction factor, and pressure gradient can be obtained using the fuzzy logic value for the horizontal liquid slip holdup equation and the original or modified Beggs Brill correlation and flow pattern map for all other parameters such as the Beggs Brill d, e, f and g coefficients.

TABLE 5
Inference rules for the Fuzzy logic flow pattern map.

| | If | | then | | |
|---|---|---|---|---|---|
| | λ_{L} | N_{FR} | a | b | c |
| 1 | extremely-low | very-low | seg. | very-high-seg. | seg. |
| 2 | extremely-low | low | seg. | extremely-high-seg. | seg. |
| 3 | extremely-low | low-medium | seg. | extremely-high-seg. | seg. |
| 4 | extremely-low | medium | seg. | extremely-high-seg. | seg. |
| 5 | extremely-low | high | dist. | low-dist. | dist. |
| 6 | extremely-low | very-high | dist. | medium-dist. | dist. |
| 7 | very-low | very-low | seg. | very-high-seg. | seg. |
| 8 | very-low | low | seg. | extremely-high-seg. | seg. |
| 9 | very-low | low-medium | seg. | extremely-high-seg. | seg. |
| 10 | very-low | medium | dist. | low-dist. | dist. |
| 11 | very-low | high | dist. | low-dist. | dist. |
| 12 | very-low | very-high | dist. | medium-dist. | dist. |
| 13 | low-medium | very-low | seg. | medium-seg. | seg. |
| 14 | low-medium | low | seg. | extremely-high-seg. | seg. |
| 15 | low-medium | low-medium | seg. | extremely-high-seg. | seg. |
| 16 | low-medium | medium | dist. | very-low-dist. | dist. |
| 17 | low-medium | high | dist. | low-dist. | dist. |
| 18 | low-medium | very-high | dist. | highly-dist. | dist. |
| 19 | medium | very-low | seg. | very-high-seg. | seg. |
| 20 | medium | low | seg. | medium-seg. | seg. |
| 21 | medium | low-medium | seg. | extremely-high-seg. | seg. |
| 22 | medium | medium | inter. | inter. | inter. |
| 23 | medium | high | inter. | inter. | inter. |
| 24 | medium | very-high | dist. | highly-dist. | dist. |
| 25 | high-medium | very-low | seg. | very-high-seg. | seg. |
| 26 | high-medium | low | seg. | low-seg. | seg. |
| 27 | high-medium | low-medium | seg. | low-seg. | seg. |
| 28 | high-medium | medium | seg. | extremely-high-seg. | seg. |
| 29 | high-medium | high | dist. | low-dist. | dist. |
| 30 | high-medium | very-high | dist. | highly-dist. | dist. |
| 31 | high | very-low | seg. | very-high-seg. | seg. |
| 32 | high | low | seg. | extremely-high-seg. | seg. |
| 33 | high | low-medium | inter. | inter. | inter. |
| 34 | high | medium | dist. | medium-dist. | dist. |
| 35 | high | high | dist. | highly-dist. | dist. |
| 36 | high | very-high | dist. | highly-dist. | dist. |
| 37 | very-high | very-low | inter. | inter. | inter. |
| 38 | very-high | low | inter. | inter. | inter. |
| 39 | very-high | low-medium | inter. | inter. | high- |
| | | | | | inter. |
| 40 | very-high | medium | dist. | highly-dist. | dist. |
| 41 | very-high | high | dist. | highly-dist. | dist. |
| 42 | very-high | very-high | dist. | highly-dist. | dist. |
| 43 | extremely-high | very-low | inter. | inter. | inter. |
| 44 | extremely-high | low | extrem.- | highly-dist. | dist. |
| | | | dist. | | |
| 45 | extremely-high | low-medium | extrem.- | highly-dist. | high- |
| | | | dist. | | inter. |
| 46 | extremely-high | medium | extrem.- | highly-dist. | dist. |
| | | | dist. | | |
| 47 | extremely-high | high | extrem.- | highly-dist. | dist. |
| | | | dist. | | |
| 48 | extremely-high | very-high | extrem.- | highly-dist. | dist. |
| | | | dist. | | |

In one non-limiting embodiment of the fuzzy method for predicting liquid slip holdup, the membership functions corresponding to the fuzzy sets for the Froude number and the no-slip holdup are trapezoid or triangle functions like those in FIG. 5 and FIG. 6, and the corner values (where the membership function is zero) and peak values (where the membership function is one) are given in Table 5. Each of these membership functions in this embodiment is defined as either a triangle function or a trapezoid function, but embodiments with curved or more elaborate and complicated membership function shapes are also possible. Examples of more complicated membership function include Gaussian functions, spline functions, etc. The simplicity of the triangle and trapezoid functions is that they can be defined by two values for the corners (corresponding to the vertices where function is zero) and either one or two values for peaks (corresponding to the vertices where the function has a value of one). Table 5 shows the corner and peak values for each of the input membership functions. The fuzzification process for a given input consists of finding the membership values for each fuzzy set by applying the corresponding membership function. Each fuzzy set admits the possibility of partial membership in the fuzzy set.

Each of the Beggs Brill a, b, and c coefficients also has a collection of membership functions and fuzzy sets defined. The membership functions for these outputs are all triangle functions, and the peak and corner values are given in Table 7 and Table 8. General the membership value is one at the peak and zero at the corners. However, for the Beggs Brill c coefficient membership functions, the peak membership value is different for different fuzzy sets (similar to those membership function shown in the bottom plot of FIG. 7). Therefore, in Table 8, where the Beggs Brill c coefficient membership functions are described, the peak membership value is one of the parameters given. For all membership functions where the peak membership value is not given the peak membership value is one.

TABLE 6
Definitions of membership functions for Beggs Brill
inputs: no-slip holdup and Froude number.
Fuzzy Set Membership Functions

| Variable | Name | Corner 1 | Peak 1 | Peak 2 | Corner 2 |
|---|---|---|---|---|---|
| No-slip | extremely- | 0 | 0 | 5.00E−04 | 1.00E−03 |
| Holdup | low | | | | |
| | very-low | 5.00E−04 | 1.00E−03 | NA | 1.50E−03 |
| | low-medium | 1.00E−03 | 1.50E−03 | 3.00E−03 | 4.00E−03 |
| | medium | 3.00E−03 | 4.00E−03 | 1.00E−02 | 1.00E−02 |
| | high-medium | 1.00E−02 | 1.00E−02 | NA | 1.00E−01 |
| | high | 5.00E−02 | 1.00E−01 | 2.00E−01 | 3.00E−01 |
| | very-high | 2.00E−01 | 3.00E−01 | 4.00E−01 | 5.00E−01 |
| | extremly | 4.00E−01 | 5.00E−01 | 1.00E+00 | 1.00E+00 |
| | high | | | | |
| Froude | very-low | NA | 0.00E+00 | 1.00E+00 | 1.00E+01 |
| Number | low | 1.00E+00 | 1.00E+01 | NA | 2.00E+01 |
| | medium-low | 1.00E+01 | 2.00E+01 | 4.00E+01 | 1.00E+02 |
| | medium | 4.00E+01 | 1.00E+02 | 1.50E+02 | 2.00E+02 |
| | high | 1.50E+02 | 5.00E+02 | NA | 2.00E+03 |
| | very-high | 5.00E+02 | 2.00E+03 | 4.80E+03 | 5.00E+03 |

TABLE 7
Values for thecorners and peaks of the Beggs
Brill a and b triangle membership functions.

| | | Corner 1 | Vertex | Corner 2 |
|---|---|---|---|---|
| a | extreme-distributed | NA | 0.800 | 0.825 |
| | intermittent | 0.840 | 0.845 | 0.850 |
| | segregated | 0.900 | 0.910 | 0.920 |
| | distributed | 1.060 | 1.065 | 1.070 |
| b | very-highly-segregated | 0.3000 | 0.3200 | 0.3600 |
| | high-segregated | 0.3300 | 0.3600 | 0.3800 |
| | medium-segregated | 0.3600 | 0.3850 | 0.4200 |
| | low-segregated | 0.4000 | 0.4200 | 0.4500 |
| | very-low-segregated | 0.4400 | 0.4600 | 0.4800 |
| | extremely-low-segregated | 0.4700 | 0.4846 | 0.5000 |
| | intermitttent | 0.5300 | 0.5351 | 0.5400 |
| | very-low-distributed | 0.5450 | 0.5500 | 0.5600 |
| | low-distributed | 0.5550 | 0.5650 | 0.5750 |
| | medium-distributed | 0.5750 | 0.5824 | 0.6000 |
| | highly-distributed | 0.6000 | 0.6300 | 0.6500 |

TABLE 8
Values for location of thecorners and peaks of thetriangle membership
functions for the Beggs Brill c coefficient and the height (membership
value) of the peak of the triangle membership functions.

| | | Corner 1 | Vertex | Height | Corner 2 |
|---|---|---|---|---|---|
| c | intermitttent | 0.0170 | 0.0173 | 0.5000 | 0.0176 |
| | high-intermitttent | 0.0510 | 0.0530 | 1.0000 | 0.0550 |
| | distributed | 0.0604 | 0.0609 | 0.7500 | 0.0615 |
| | segregated | 0.0863 | 0.0868 | 0.9000 | 0.0873 |

In one embodiment the fuzzy logic method for predicting liquid slip holdup is performed using digital circuits configured for performing mathematical and logical operations. This processing circuitry performs all of the functions described above of including: determining antecedents using predefined membership functions and logic operations to obtain an antecedent value, applying implication rules to obtain consequent membership functions, aggregating consequent membership functions and applying the defuzzification rule to obtain single valued outputs, and applying the single-valued output, i.e. the Beggs Brill a, b, and c coefficients, to obtain the liquid slip holdup using the Beggs Brill equations for liquid slip holdup.

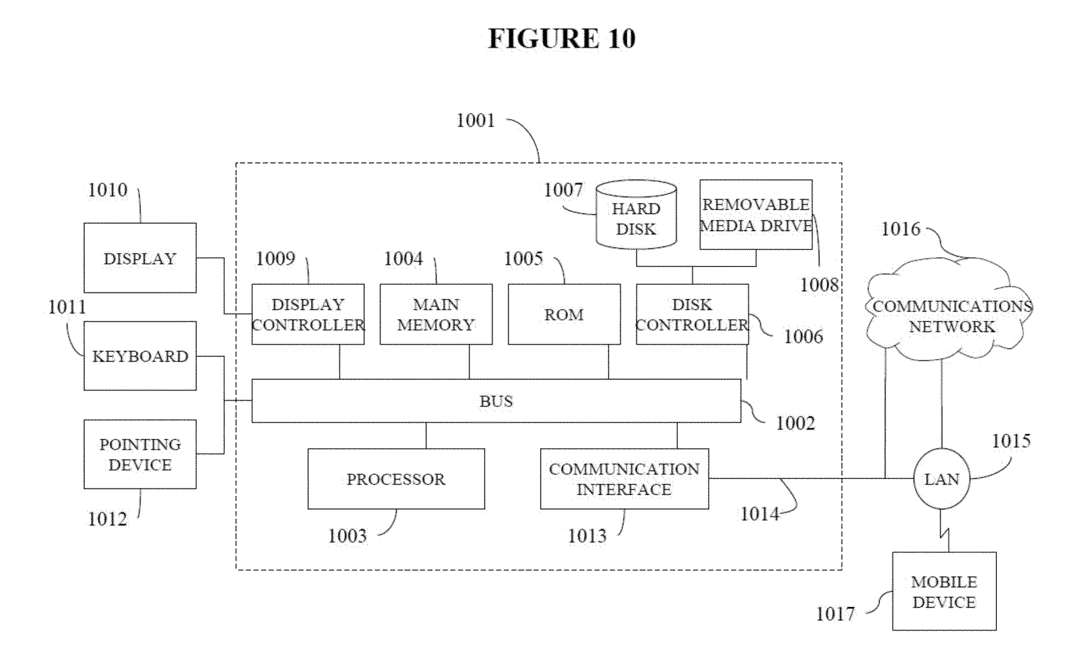

Next, a hardware description of the device according to exemplary embodiments is described with reference to FIG. 10. In FIG. 10, the device includes a CPU 1000 which performs the processes described above. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

The device in FIG. 10 also includes a network controller 1006, such as an Intel Ethernet PRO network interface card from Intel Corporation of America, for interfacing with a network. As can be appreciated, the network can be a public network, such as the Internet, or a private network such as an LAN or WAN network, or any combination thereof and can also include PSTN or ISDN sub-networks. The network can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010 General purpose I/O interface also connects to a variety of peripherals 1018 including printers and scanners, such as an OfficeJet or DeskJet from HewlettPackard.

A sound controller 1020 is also provided in the device, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

In one embodiment, the fuzzy method for predicting no-slip holdup is used in a system to detect changes to pipe flow, such changes include the buildup of hydrates and wax (e.g. paraffins) within the pipe or leaks through the pipe wall. The system applies sensors at multiple points along the pipe in order to measure various characteristics of the multiphase flow such as flow rate, pressure, etc. The improved Beggs Brill method using fuzzy logic predicts the flow characteristics at measurement points upstream and downstream from the sensor positions. By comparing the predicted pressure drop using the improved Beggs Brill method with the measured pressure drop along the pipe as measuresd by the above mentioned sensors, the system alarms when the measured pressure drop differs significantly from the predicted pressure drop calculated using the improved Beggs Brill method. The improved Beggs Brill method improves the accuracy of the predicted pressure drop such that smaller alarm thresholds can be used without increasing the false alarm rate. In order to isolate and repair malfunctioning sections of pipe, a user of the system whould use multiple sensor locations along the pipe and also vary the flow rate through the pipe, in order to pinpoint which section of the pipe is responsible for deviations from expected operations.

In one embodiment, the fuzzy method for predicting no-slip holdup is used in a system with only a single multiphase sensor in the pipe. The multiphase sensor measures flow rate, pressure, and other characteristics of the multiphase flow. The system uses measurements from the sensor and the improved Beggs Brill method for predicting flow regime and pressure drop to predict how the system would function, if the pump rate was increased or decreased. For example, the system uses the improved Beggs Brill method to make predictions of the flow rate and flow pattern throughout the pipe in order to optimize flow rate and flow assurance. The optimization is performed using these feed-forward predictions of the flow rate to choose system parameters, such as the pump pressure or valve aperture, that are predicted to display more favorable operating characteristics such as more a stable flow pattern, faster flow rate, a flow rate with better long term assurance, lower accretion rates of hydrates on the pipe wall, or a combination of these desired characteristics.

Obviously, numerous modifications and variations of the present invention are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method for predicting multiphase flow in pipes, the method comprising;
defining a flow pattern map, wherein a Froude number and a no-slip holdup are related to flow pattern regimes, where the Froude number and the no-slip holdup are single-valued numbers, and where the flow pattern regimes are fuzzy sets;
defining Froude number membership functions relating the Froude number to membership values which quantify the membership in Froude number fuzzy sets;
defining no-slip holdup membership functions relating the no-slip holdup to membership values which quantify the membership in no-slip holdup fuzzy sets;
defining Beggs-Brill a membership functions assigning membership values to Beggs-Brill a fuzzy sets;
defining Beggs-Brill b membership functions assigning membership values to Beggs-Brill b fuzzy sets;
defining Beggs-Brill c membership functions assigning membership values to Beggs-Brill c fuzzy sets;
inferring a plurality of consequents using a plurality of fuzzy inference rules, wherein the plurality of antecedents are determined by applying fuzzy logic operations to the Froude number fuzzy sets and the no-slip holdup fuzzy sets, and wherein the plurality of consequents are determined by applying an implication method to the Beggs-Brill a fuzzy sets, Beggs-Brill b fuzzy sets, and Beggs-Brill c fuzzy sets;
aggregating all Beggs-Brill a consequents to obtain a Beggs-Brill a aggregate, and defuzzifying the Beggs-Brill a aggregate to obtain a single-valued Beggs-Brill a coefficient;
aggregating all Beggs-Brill b consequents to obtain a Beggs-Brill b aggregate, and defuzzifying the Beggs-Brill a aggregate to obtain a single-valued Beggs-Brill b coefficient;
aggregating all Beggs-Brill c consequents to obtain a Beggs-Brill c aggregate, and defuzzifying the Beggs-Brill c aggregate to obtain a single-valued Beggs-Brill c coefficient;
predicting the horizontal liquid-slip holdup, H_{L} (0), by applying the Beggs-Brill a, b, and c coefficients and the Froude number, N_{FR}, and a no-slip holdup, λ_{L}, to the horizontal liquid-slip holdup equation
H_{L}(0)=aλ_{L}^{b}/N_{FR}^{c};
using the predicted horizontal liquid-slip holdup with the Beggs Brill correlation to predict additional flow parameters and system performance for multiphase flow in pipes, including calculating the angled and vertical liquid-slip holdup, the friction factor, and pressure drop along a pipe, flow assurance.

2. The method in claim 1, wherein the defuzzification method is the centroid method.

3. The method in claim 2, wherein the fuzzy logic OR operator outputs the maximum of the two input membership values, and the fuzzy logic AND operator outputs the minimum of the two input membership values.

4. The method in claim 3, wherein the implication method employed by the fuzzy inference rules is the minimum implication method, wherein the minimum implication method truncates membership values of the consequent membership function such that membership values greater than the antecedent are set equal to the antecedent.

5. The method in claim 4, wherein the aggregation rule is to sum over the output sets for all fuzzy inference rules.

6. The method in claim 4, wherein the aggregation rule is to take the maximum of all output sets for all fuzzy inference rules.

7. A system performing the method according to claim 1, the system comprising:
a pipe configured for multiphase flow;
a first sensor arranged in the pipe and configured to measure the pressure in the pipe and to measure the flow rate through the pipe;
a second sensor arranged in the pipe at a location distant from the first sensor and configured to measure the pressure in the pipe and to measure the flow rate through the pipe;
a special purpose computer receiving measurements from the first sensor and measurements from the second sensor, wherein the special purpose computer uses the measurements from the first sensor to perform the method for predicting multiphase flow in pipes and predicts a liquid-slip holdup, wherein the liquid-slip holdup is used by the special purpose computer to predict the pressure drop in the pipe between the first sensor and the second sensor, and an alarm is signaled when the absolute value of the difference between the predicted the pressure drop and the measured pressure drop exceeds a predefined threshold.

8. A device for predicting liquid slip holdup in multiphase flow in pipes, the device comprising:
a computer storage comprising a non-transitory computer readable storage medium;
processing circuitry configured to calculate membership functions for Froude number fuzzy sets and recording Froude number membership functions in the computer storage;
processing circuitry configured to calculate membership functions for no-slip holdup fuzzy sets and recording no-slip holdup membership functions in the computer storage;
processing circuitry configured to determine fuzzy inference rules and store the fuzzy inference rules in the computer storage;
processing circuitry configured to calculate membership functions for Beggs Brill ‘a’ coefficient fuzzy sets and storing Beggs Brill ‘a’ membership functions in the computer storage;
processing circuitry configured to calculate membership functions for Beggs Brill ‘b’ coefficient fuzzy sets and storing Beggs Brill ‘b’ membership functions in the computer storage;
processing circuitry configured to calculate membership functions for Beggs Brill ‘c’ coefficient fuzzy sets and storing Beggs Brill ‘c’ membership functions in the computer storage;
processing circuitry configured to receive a Froude number value and the Froude number membership functions, and to calculate Froude number membership values for the Froude number fuzzy sets;
processing circuitry configured to receive a no-slip holdup value and the no-slip holdup membership functions, and to calculate no-slip holdup membership values for the no-slip holdup fuzzy sets;
processing circuitry configured to receive a single-valued Froude number, a single-valued no-slip holdup, the Froude number membership functions and to receive the no-slip holdup membership functions and configured to use the received Froude number membership functions and the no-slip holdup membership functions to calculate membership values for no-slip holdup fuzzy sets and to calculate membership values for Froude number fuzzy sets; processing circuitry configured to receive the no-slip holdup membership values, to receive the Froude number membership values, and to calculate antecedent values for fuzzy inferences rules by performing logic operations on the no-slip holdup membership values and the Froude number membership values;
processing circuitry configured to receive antecedent values, Beggs Brill ‘a’ membership functions, and fuzzy inference rules and to calculate consequent ‘a’ membership functions by applying an implication rule and the fuzzy inference rules to the antecedent values and to the Beggs Brill ‘a’ membership functions;
processing circuitry configured to receive the consequent ‘a’ membership functions and to calculate an aggregate ‘a’ membership function by aggregating the consequent ‘a’ membership functions;
processing circuitry configured to receive the aggregate ‘a’ membership function and to calculate a single-valued Beggs Brill ‘a’ coefficient by applying a defuzzification rule to the aggregate ‘a’ membership function;
processing circuitry configured to receive antecedent values, Beggs Brill ‘b’ membership functions, and fuzzy inference rules and to calculate consequent ‘b’ membership functions by applying an implication rule and the fuzzy inference rules to the antecedent values and to the Beggs Brill ‘b’ membership functions;
processing circuitry configured to receive the consequent ‘b’ membership functions and to calculate an aggregate ‘b’ membership function by aggregating the consequent ‘b’ membership functions;
processing circuitry configured to receive the aggregate ‘b’ membership function and to calculate a single-valued Beggs Brill ‘b’ coefficient by applying a defuzzification rule to the aggregate ‘b’ membership function;
processing circuitry configured to receive antecedent values, Beggs Brill ‘c’ membership functions, and fuzzy inference rules and to calculate consequent ‘c’ membership functions by applying an implication rule and the fuzzy inference rules to the antecedent values and to the Beggs Brill ‘c’ membership functions;
processing circuitry configured to receive the consequent ‘c’ membership functions and to calculate an aggregate ‘c’ membership function by aggregating the consequent ‘c’ membership functions;
processing circuitry configured to receive the aggregate ‘c’ membership function and to calculate a single-valued Beggs Brill ‘c’ coefficient by applying a defuzzification rule to the aggregate ‘c’ membership function;
processing circuitry configured to receive the single-valued Beggs Brill ‘a’ coefficient, the single-valued Beggs Brill ‘b’ coefficient, the single-valued Beggs Brill ‘c’ coefficient, the Froude number value, N_{FR}, and the no-slip holdup value, λ_{L}, and to calculate a liquid-slip holdup, H_{L}(0), using the equation H_{L}(0)=aλ_{L}^{b}/N_{FR}^{c}.
